(19) United States
(12) Patent Application Publication
(10) Pub. No.: US 2019/0163285 A1
(43) Pub. Date: May 30, 2019

(54) METHOD FOR INTERACTION BETWEEN AN OPERATOR AND A TECHNICAL OBJECT

(71) Applicant: SIEMENS AKTIENGESELLSCHAFT, München (DE)

(72) Inventors: Joseph Newman, Unterhaching (DE); Asa MacWilliams, Fürstenfeldbruck (DE)

(21) Appl. No.: 16/315,246

(22) PCT Filed: Jun. 30, 2017
(86) PCT No.: PCT/EP2017/066238

§ 371 Date: Jan. 4, 2019

(30) Foreign Application Priority Data
Jul. 5, 2016 (DE) 10 2016 212 234.7

(51) Int. Cl. G06F 3/01

(52) U.S. Cl. CPC G06F 3/017; G06F 3/014; G06F 3/016

(57) ABSTRACT

The method provides an activation of an interaction system, a choosing process, a selection, a control, and a release of a technical object by performing gestures by an arm movement of the operator. The gestures may be detected using inertial sensors provided in the lower arm region of the operator or also by optically detecting the arm gestures. In comparison to known choosing methods which likewise provide pointing gestures for aiming a technical object or also analyze a position or orientation of the operator in order to choose technical objects, a two-step process, (e.g., a combination of a choosing gesture and a selecting gesture), allows a substantially more precise choosing process and interaction in the method according to the invention. In comparison to a screen-based interaction, the method allows a more intuitive interaction with technical objects.

The present patent document is a § 371 nationalization of PCT Application Serial No. PCT/EP2017/066238, filed Jun. 30, 2017, designating the United States, which is hereby incorporated by reference, and this patent document also claims the benefit of German Patent Application No. DE 10 2016 212 234.7, filed Jul. 5, 2016, which is also hereby incorporated by reference.

### TECHNICAL FIELD

The disclosure relates to a method for interaction between an operator and a technical object.

Such a method is used, for example, in building automation and in industrial automation, in production machines or machine tools, in diagnostic-support or service-support systems and in the operation and maintenance of complex components, devices and systems, in particular of industrial or medical installations.

### BACKGROUND

The prior art discloses methods which provide for an object which is to be controlled to be chosen, followed by an operating action or interaction with the technical object. For example, building-automation systems which, from a central input location, provide for a choosing operation and interaction—in the simplest variant a switch-on and switch-off operation—with various technical objects, (e.g., lighting devices and blinds), are known.

Also known, likewise in building-automation systems, is control by voice input, this providing, for example, for a spoken choice of a room, followed by adjustment of the room temperature. In anticipation of the objects on which the disclosure is based, voice control does already provide the advantage of hands-free interaction of the technical objects, but voice commands which have to be learnt mean that operation is not particularly intuitive.

A further interaction of technical objects involves the use of mobile devices as a pointer. Position sensors in the mobile device pick up the fact that an object is being aimed at. Interaction then takes place with an input device or mechanism of the mobile device. The choosing of one among a plurality of objects using this method, meanwhile, takes place with sufficient precision only if the plurality of objects are sufficiently separated. Furthermore, this interaction method also has the disadvantage that hands-free operation is not supported: the operator has to hold a mobile device. Known infrared remote-control devices or mechanisms likewise have the disadvantage that operation is not hands-free.

To summarize, measures which are known at present for interaction purposes take place in a non-contactless manner, unreliably or with input-device use which is not suited to the relevant working environment.

### SUMMARY AND DESCRIPTION

In contrast, the present disclosure has the object of providing for an interaction system involving intuitive and hands-free choosing of a technical object and interaction with the technical object.

The scope of the present disclosure is defined solely by the appended claims and is not affected to any degree by the statements within this summary. The present embodiments may obviate one or more of the drawbacks or limitations in the related art.

The method for interaction between an operator and a technical object provides for detection of a plurality of local parameters assigned to at least one arm of the operator being detected by a gesture-detection unit of an interaction system. The plurality of local parameters are evaluated as a respective gesture by a control unit of the interaction system, wherein a choosing operation and interaction with the selected object are controlled by a sequence of gestures. The following sequence is carried out here in the order mentioned hereinbelow.

In act a), an initiating gesture for activating the interaction system is detected. In act b), a choice gesture is detected, first target coordinates are determined from the plurality of local parameters assigned to the choice gesture, and the first target coordinates are assigned to one or more objects identified by retrievable location coordinates. In act c), feedback assigned to the one or more identified objects is activated in order to confirm to the operator a choice of one or more identified objects. In act d), in the case of a plurality of identified objects, a selection gesture is detected, second target coordinates are determined from the plurality of local parameters assigned to the selection gesture, and the second target coordinates are assigned to an object identified by retrievable location coordinates. In act e), a confirmation gesture is detected and the identified object is assigned to an interaction mode on account of the confirmation gesture. In act f), the object assigned to an interaction mode is controlled by a plurality of interaction gestures. In act g), a release gesture for releasing the object assigned to an interaction mode is detected.

If the detection of the choice gesture in act b) gives rise to assignment in relation to merely one object identified by retrievable location coordinates, rather than a plurality of objects, act d) is skipped.

The disclosure provides for activation of the system, choosing, selection, control and release of an object by the formation of gestures with the aid of a movement of the operator's arms. Gesture detection may be performed by inertia sensors provided in the region of the operator's forearm or else by optical detection of the arm gestures.

Choosing, or choice, here is to be understood to mean a rough choice of a first quantity of identified objects with the aid of a choice gesture. The “first quantity of identified objects” mentioned, of course, does not preclude the quantity identified with the aid of the choice gesture corresponding to precisely one identified object. In contrast, selection, or a selecting operation, is to be understood to mean a precise choice made from the first quantity with the aid of a selection gesture, with the aim of selecting precisely one identified object from the previous rough choice.

Interaction systems which are already known try to provide for technical objects to be chosen by a pointing operation. However, the realization of the choosing operation may break down on account of involuntary activation and of an imprecise choosing operation of the technical objects, in particular when the latter are closely adjacent. In contrast, the method provides a sequence of gestures for choosing and interacting with technical objects which are distinct from one another and, by the provision of a selection gesture following a choice gesture, provide for a progressively more precise choice.

A particular advantage of the disclosure is achieved by the possibility of assigning individual gestures, (e.g., the choice gesture, the selection gesture, the confirmation gesture, etc.), an intuitive and well-known movement progression which is known, for example, from operation of a lasso.

In contrast to conventional interaction systems, the operation of the interaction system is contactless, and therefore an operator in an industrial or medical environment has no need to operate input devices with contaminating action.

A further advantage is that, during the operating actions, the operator has no need to look at an output device, for example, a screen. Instead, the operator may directly view the technical objects which are to be operated. In actual fact, it is also possible for the operator to effect operation even without looking, for the case where the operator is sufficiently familiar with the surroundings and the technical objects which are to be operated and the location thereof. The additional provision of haptic feedback according to an embodiment mentioned hereinbelow enhances this effect of operation without looking.

In contrast to conventional approaches—e.g., voice control or choosing an object with the aid of a mobile device—the interaction method provides for quicker and more precise choosing of technical objects. Furthermore, the method is less susceptible to undesirable, incorrect operation. Choosing distinct gestures according to the exemplary embodiments mentioned hereinbelow gives rise to a further reduction in error susceptibility.

In comparison with known choosing methods which likewise provide pointing gestures for aiming at a technical object, or also evaluate a position or orientation of the operator for choosing technical objects, a two-act process, (that is to say a combination of a choice gesture and of a selection gesture), render significantly more precise choosing and interaction possible. In comparison with screen-based interaction, the method renders more intuitive interaction with technical objects possible.

A particular advantage is also constituted by the feedback for confirming to the operator a choice of the objects. This measure makes it possible for an operator to detect and identified object visually, but not necessarily to come into contact with the object—for example as a result of conventional actuation by actuating units—or to approach the same—for example for detection of a barcode assigned to the object—within the context of the interaction.

### BRIEF DESCRIPTION OF THE DRAWINGS

Further exemplary embodiments and advantages will be explained in more detail hereinbelow with reference to the drawings.

FIG. 1 depicts a schematic structural illustration of a rearview of an operator as the operator is making a first gesture.

FIG. 2 depicts a schematic structural illustration of the rearview of the operator as the operator is making a second gesture.

FIG. 3 depicts a schematic structural illustration of the rearview of the operator as the operator is making a third gesture.

FIG. 4 depicts a schematic structural illustration of the rearview of the operator as the operator is making a fourth gesture.

FIG. 5 depicts a schematic structural illustration of a front view of the operator.

### DETAILED DESCRIPTION

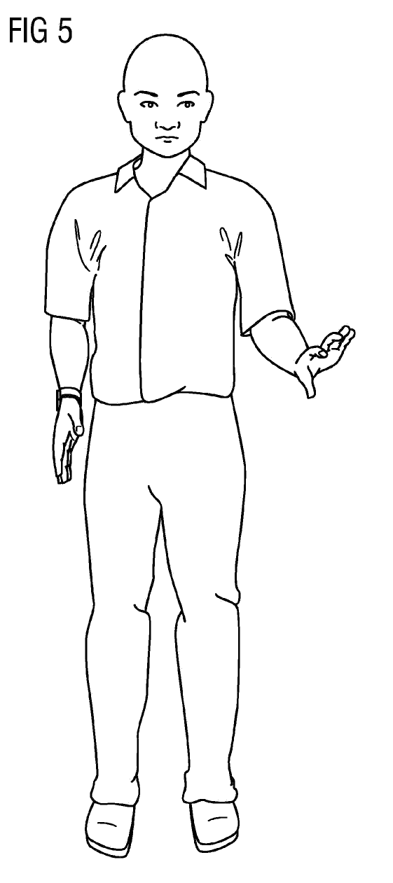

FIG. 5 depicts a front view of an operator as the operator is making a gesture. The operator is assigned a gesture-detection unit, which in the exemplary embodiment is worn on the operator's right wrist. In alternative embodiments, the gesture-detection unit is worn on the left wrist or on both wrists. The gesture-detection unit includes a plurality of inertial sensors for detecting a plurality of local parameters assigned to the operator's posture, in particular local parameters which are formed by movement, rotation and/or positioning of the operator's arms. The plurality of local parameters are evaluated as a respective gesture by a control unit—not illustrated—of the interaction system. Gesture control takes place intuitively with a movement and/or rotation of the body, in particular of one or both forearms. There is no need for an input device, which may be inappropriate in an industrial environment.

According to one embodiment, provision is made for the gesture-detection unit used to be a commercially available smartwatch. A particular advantage of this embodiment of the gesture-detection unit is that use may be made of commercially available smartwatches equipped with inertial sensors. Such a wearable gesture-detection unit makes it possible to reuse a good number of functional units used in the disclosure, or in developments, for example, gesture detection based on inertial sensors, a localization unit (based, for example, on Bluetooth beacons), and haptic feedback, for example, an unbalanced motor for giving out vibration feedback to the operator's wrist.

Alternative gesture-detection units provide, for example, for optical detection of gestures for example using one or more optical detection devices which detect the operator's posture three-dimensionally, for example using time-of-flight methods or structured light topometry. The methods mentioned likewise have the advantage of hands-free operation, but require the use of optical detection devices in the operator's surroundings.

A further constituent part of the interaction system is at least the control unit for picking up the gestures detected by the gesture-detection unit and for processing the operator's interaction with the at least one technical object, the interaction being triggered by the operator's gestures.

By the interaction system, a plurality of local parameters assigned to at least one arm of the operator are detected by the gesture-detection unit and are evaluated at a respective gesture by the control unit, wherein choosing and interaction with the chosen object are controlled by a sequence of gestures.

The text which follows will explain interaction with a lighting device which is to be chosen and activated, and forms an example of a technical object. Following initiation of the interaction system, a certain lighting device is chosen from a plurality of lighting devices and is switched on.

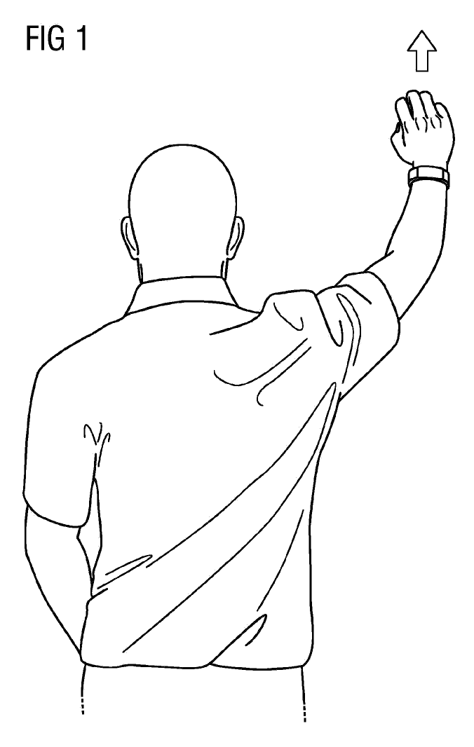

FIG. 1 depicts a schematic structural illustration of a rearview of an operator as the operator is making an initiating gesture. The initiating gesture includes one arm of the operator being raised. As an option, the initiating gesture includes a rotation of a palm of the hand in the direction of a center of the operator's body. The initiating gesture is detected by the interaction system and activates the latter for the following interaction between the operator and the technical object. As an option, e.g., as a result of the gesture-detection unit being worn on the wrist, haptic feedback is given out to the operator in order to signal the readiness of the interaction system.

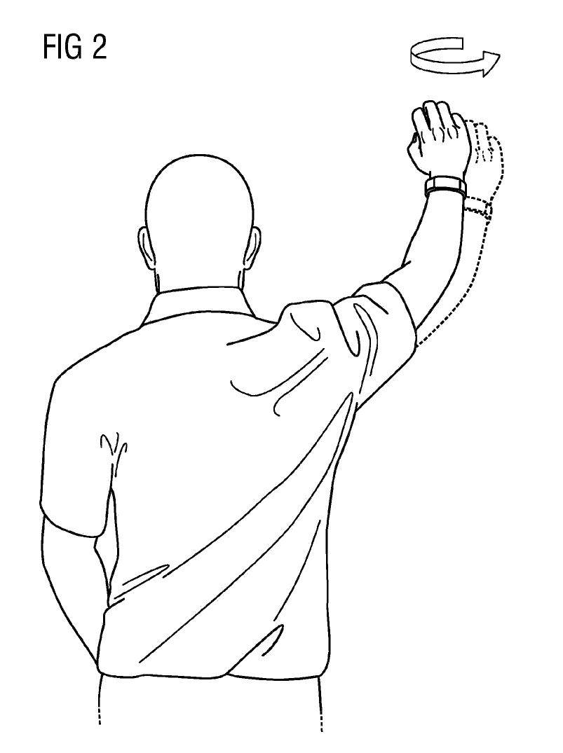

FIG. 2 depicts the operator as the operator continues the initiating gesture, which includes a circular movement about a main axis of the operator's forearm. The palm of the hand here remains directed toward the center of the operator's body. A configuration of the choice gesture provides a gyratory movement of the wrist, that is to say a circular movement, (e.g., of the right wrist), along an imaginary circular line, with the operator's hand raised. This choice gesture corresponds to an imaginary actuation of a virtual lasso prior to the latter being thrown.

As an option, as a result of the gesture-detection unit being worn on the wrist, haptic feedback is given out to the operator in order to signal the readiness of the interaction system for the subsequent choosing of an object.

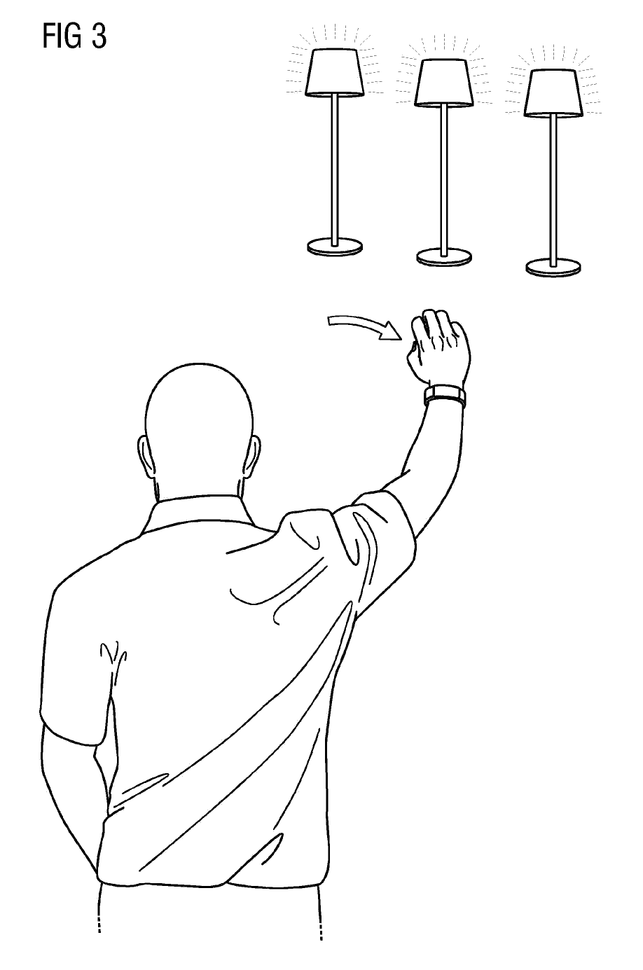

FIG. 3 depicts the operator as the operator is making a choice gesture. The choice gesture includes, for example, a throwing movement in the direction of a technical object which is to be chosen and is to be identified by the interaction system. Continuing the movement progression of the initiating gesture, this choice gesture corresponds to an imaginary throwing action of the virtual lasso in the direction of the object which is to be chosen.

In an alternative configuration of the initiating gesture and of the choice gesture, a virtual throwing movement with a hand which has been previously raised triggers a choosing action for which the gestures correspond approximately to the actuation of a virtual harpoon. The movement progression corresponds to the above-described lasso movement, with the exception that there is no initiating circular movement. According to this embodiment, the choice gesture is therefore less distinct than the lasso movement and possibly results in an increased number of undesired initiating or choosing activations.

The situation of FIG. 3 depicts three lighting sources which are close enough for choosing over a plurality of acts to be advantageous. The choice gesture here, as shown hereinbelow, results in a plurality of identified objects which, refined by a selection gesture, finally result in a single identified object, that is to say the object which is actually to be controlled by the operator. Let's say that, of the three lighting sources illustrated in FIG. 3, this object which is to be controlled is the lighting source arranged on the far left.

Following a choice gesture recognized as valid by the interaction system, first target coordinates are determined from the plurality of local parameters assigned to the choice gesture. The plurality of local parameters assigned to the choice gesture include, in particular, the position of the operator and the direction of the throwing movement.

These first target coordinates are assigned to one or more objects identified by retrievable location coordinates, in the example the three lighting sources. The location coordinates of these three lighting sources are for example provided in, or may be retrieved from, a data source, which is of any desired configuration and to which the interaction system has access. Should it be possible for the first target coordinates to be clearly assigned to a particular identified object, there is no need for the subsequent selection gesture.

In order to confirm to the operator a choice of one or more identified objects, feedback, which is assigned to the identified objects individually or as a whole, is activated. In the present exemplary embodiment, the feedback is immanent in the respective lighting sources—the latter flash for confirmation purposes.

According to alternative embodiments, assigned feedback may also include separate feedback means, for example, when the technical objects themselves do not contain any suitable feedback means. This applies, for example, to a chosen pump which is located in a production environment and does not include any acoustic or optical signal generator. For feedback purposes, a corresponding signal or indication to choose the pump would appear on a display panel of the industrial installation, and therefore this display panel in the embodiment mentioned is to be understood to refer to a feedback assigned to the identified object.

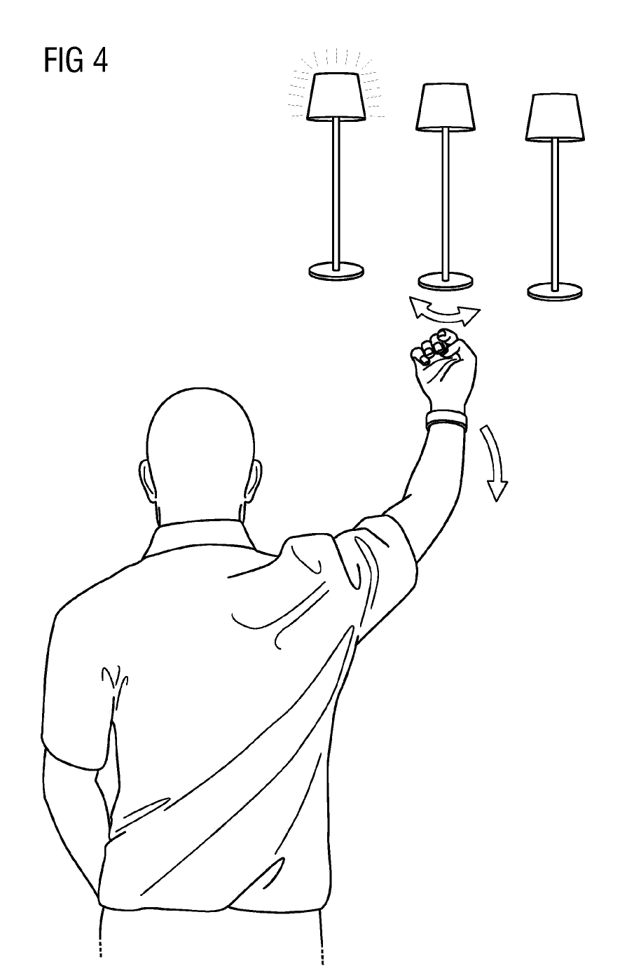

FIG. 4 depicts the operator in the course of a selection gesture which, in the case of a plurality of identified objects, may be initiated in order to refine the choice. With arm still directed toward the object which is to be chosen, the operator performs a rotary movement with his arm—for example a pronation or supination—or a translatory movement—for example a movement of one arm in the horizontal or vertical direction—or an interior or exterior rotation of the shoulder. In order to coordinate selection, the feedback assigned to the identified objects is activated. A rotary movement as far as a stop position on the left here causes for example the lighting source on the far left to light up. Constant rotation to the right causes one lighting source after the other to light up in the right-hand direction, so that the selection of the lighting source which is to be chosen may be visualized.

Such a rotary movement, (for example, a pronation or supination of the forearm), is significantly more straightforward using the inertial sensors provided in the operator's forearm region, or even using optical detection of an arm-rotation gesture, than is detection of a finger gesture.

The selection gesture is detected by second target coordinates being determined from the plurality of local parameters assigned to the selection gesture, and by the second target coordinates being assigned to the object identified by retrievable location coordinates.

If the detection of the choice gesture gives rise to an assignment in relation to merely one object identified by retrievable location coordinates, rather than a plurality of objects, the selection act is advantageously skipped.

Once the desired object has been chosen and identified, with the aid of the activated feedback, the operator may then initiate a confirmation gesture.

An exemplary confirmation gesture includes a forward-directed arm which is drawn back in the direction of the operator and/or is drawn upward. Continuing the intuitive semioptics of lasso operation—this gesture would correspond to a lasso being pulled tight.

The interaction system detects the confirmation gesture, optionally gives out feedback to the operator and assigns the identified object to a subsequent interaction mode.

The object assigned to an interaction mode is controlled by a plurality of interaction gestures which may be made as a matter of common practice in the art. For example, a rotary movement results in a valve being closed, a raising movement results in shading devices or mechanisms being opened, an upward movement results in an increase in the intensity of light in a room, a rotary movement results in a change in the color of the light, etc.

Termination of the interaction is triggered by the operator making a release gesture. This release gesture results in the object assigned to the interaction mode being released by the interaction system. Release of the object, previously assigned to an interaction mode, on account of the release gesture is advantageously fed back to the operator.

An exemplary release gesture includes a forward-directed arm with the hand of that arm rotating, for example in a counterclockwise direction. Continuing the intuitive semioptics of lasso operation—this gesture would correspond to a rotary movement of a lasso which is lying loosely on the ground and in the case of which the end of the lasso is to be lifted off from an object.

In building automation, the control of technical objects may be used for switching light sources on and off or for opening or closing blinds or other shading devices.

The method is also used for choosing a certain display among a plurality of displays, for example, in appropriately equipped command-and-control centers or in medical operating theatres.

In industry, the method is used for choosing and activating pumps, valves, or the like. It is also possible to use it in production and logistics, where a certain package or production component is selected, in order to obtain more specific information about the same or to assign a certain production act to the same.

In the aforementioned examples, the method particularly satisfies the need for hands-free interaction, which is freed in particular from the necessity—common up until now—to operate an activating or handling unit for interaction purposes. Such hands-free operation is advantageous in particular in an environment which either is contaminated or has to meet stringent cleanliness requirements, or when the working environment renders the wearing of gloves a necessity.

An advantageous configuration provides for a multiple selection of identified objects which are to be transferred to the interaction mode. This configuration provides, for example, for the choosing of multiple lamps which are to be switched off. This multiple choosing action is provided by an alternative confirmation gesture by way of which one or more objects identified beforehand by a choice gesture and/or selection gesture are supplemented by further identified objects.

The alternative confirmation gesture results in assignment of a further identified object, without any changeover into an interaction mode taking place on account of the alternative confirmation gesture. An exemplary alternative confirmation gesture includes a forward-directed arm which is pushed forward away from the operator and/or is drawn upward. This alternative confirmation gesture is made in each case following selection of an object which is to be added, until the operator is satisfied that the plurality of identified objects are complete. In relation to the final identified object, the operator then makes the customary confirmation gesture—that is to say one arm is drawn back in the direction of the operator—and confirms his choice to be the chosen plurality of identified objects.

According to a further advantageous configuration for the multiple selection of identified objects, there is an analogy to be drawn with a known drag-and-drop mouse operation. In this case, once the confirmation gesture has been detected and the identified object has been assigned to an interaction mode, on account of the confirmation gesture, further detection of a choice gesture—in particular a throwing movement—is available, it being possible for further objects to be chosen and selected thereby. An alternative confirmation gesture is made once the object which the operator deems to be the final one has been added, and indicates that the operator is satisfied the plurality of identified objects are complete. The exemplary alternative confirmation gesture again includes, for example, one arm being pushed forward away from the operator and/or being drawn upward.

A use example of such a multiple choosing action is constituted by a monitoring center with a plurality of display devices. The operator here would like to transfer the contents of three relatively small display devices to a large-surface-area display device, so as to obtain a better overview. Using a sequence of gestures, the operator would choose the lasso-type gestures in order to choose the three display contents and the operator would then use a harpoon throw to choose the large-surface-area display device. The control system of the interaction system then rearranges the display contents appropriately.

According to an advantageous configuration, the plurality of objects identified by the choice gesture is reduced to a choice of a certain type of object. For example, in certain cases, a choice of lighting is expedient. This choice may be communicated to the interaction system before, during or even after the detection of the choice gesture, for example, by a voice command: “choose lighting only”.

According to one configuration, combination with a visualization device or mechanism, (for example, with a virtual-reality head-mounted display), is conceivable. This allows the method to be implemented in a virtual environment rather than in real surroundings, for the purpose of operating real technical objects.

Although the disclosure has been illustrated and described in detail by the exemplary embodiments, the disclosure is not restricted by the disclosed examples and the person skilled in the art may derive other variations from this without departing from the scope of protection of the disclosure. It is therefore intended that the foregoing description be regarded as illustrative rather than limiting, and that it be understood that all equivalents and/or combinations of embodiments are intended to be included in this description.

It is to be understood that the elements and features recited in the appended claims may be combined in different ways to produce new claims that likewise fall within the scope of the present disclosure. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

1. A method for interaction between an operator and a technical object, in the case of which a plurality of local parameters assigned to at least one arm of the operator is detected by a gesture-detection unit of an interaction system and are evaluated as a respective gesture by a control unit of the interaction system, wherein choosing and interaction with the chosen object are controlled by a sequence of gestures, the method comprising:
detecting an initiating gesture for activating the interaction system;
detecting a choice gesture, determining first target coordinates from the plurality of local parameters assigned to the choice gesture, and assigning the first target coordinates to one or more objects identified by retrievable location coordinates;
activating feedback assigned to the one or more identified objects in order to confirm to the operator a choice of one or more identified objects;
in the case of a plurality of identified objects, detecting a selection gesture, determining second target coordinates from the plurality of local parameters assigned to the selection gesture, and assigning the second target coordinates to an object identified by retrievable location coordinates;
detecting a confirmation gesture and assigning the identified object to an interaction mode on account of the confirmation gesture;
controlling the object assigned to an interaction mode by a plurality of interaction gestures; and
detecting a release gesture for releasing the object assigned to an interaction mode.

2. The method of claim 1, wherein the initiating gesture comprises one arm of the operator being raised.

3. The method of claim 1, wherein the initiating gesture comprises a rotation of a palm of the hand in the direction of a center of the operator's body.

4. The method of claim 1, wherein the initiating gesture comprises a circular movement about a main axis of the operator's forearm.

5. The method of claim 1, further comprising:
providing feedback to the operator following at least one respective movement of the operator in order to form the initiating gesture.

6. The method of claim 1, wherein the choice gesture comprises a throwing movement in the direction of at least one identified object.

7. The method of claim 1, wherein the selection gesture comprises a pronation or supination and/or a movement of the operator's forearm in the horizontal or vertical direction and/or a rotation of the shoulder joint.

8. The method of claim 1, further comprising:
activating feedback assigned to one or more objects identified by the second target coordinates in order to confirm to the operator a selection of at least one identified object.

9. The method of claim 1, wherein, once the identified object has been assigned to an interaction mode on account of the confirmation gesture, feedback is given out to the operator.

10. The method of claim 1, wherein, once the object assigned to the interaction mode has been released on account of the release gesture, feedback is given out to the operator.

11. The method of claim 1, wherein assignment to one or more identified objects is restricted to an adjustable type of object.

12. The method of claim 1, wherein the method is used for operating an industrial machine or medical equipment.

13. The method of claim 1, wherein the method is used for operating technical units in a building-automation system.

14. The method of claim 1, wherein the method is used for operating technical units in a virtual-reality system.
